(19) United States
(12) Patent Application Publication
(10) Pub. No.: US 2022/0214681 A1
(43) Pub. Date: Jul. 7, 2022

(54) METHOD FOR IMPROVING THE MAINTENANCE FREE OPERATING PERIOD OF AN AIRCRAFT

(71) Applicant: Simmonds Precision Products, Inc., Vergennes, VT (US)

(72) Inventors: Eric DeWind, Burlington, VT (US); Richard Joseph Sopko, Essex Junction, VT (US)

(73) Assignee: Simmonds Precision Products, Inc., Vergennes, VT (US)

(21) Appl. No.: 17/143,994

(22) Filed: Jan. 7, 2021

(51) Int. Cl. G05B 23/02; B64F 5/60; B64F 5/40

(52) U.S. Cl. CPC G05B 23/0283; B64F 5/40; B64F 5/60

(57) ABSTRACT

A method including identifying a plurality of maintenance schedules for a system each of which satisfy a minimum maintenance free operating period, monitoring and measuring a health of the system, utilizing the measured heath of the system within a degradation model in order to produce a plurality of system degradation sequences, identifying at least one maintenance event from the plurality of maintenance schedules, executing the at least one maintenance event based on the at least one identified maintenance event and utilizing the system until the next MFOP after the at least one maintenance event has been executed.

### BACKGROUND

### Technological Field

The present disclosure relates to methods for improving operation availability for a vehicle, specifically improving the maintenance free operation period (MFOP) of an aircraft.

### Description of Related Art

Aircraft component failures and un-scheduled maintenance are disruptive to planning missions and limit the overall availability of the aircraft. A Maintenance Free Operating Period (MFOP) is a concept devised to guarantee with a high probability of confidence that an aircraft will not require maintenance during a defined period of time. This allows aircraft to be deployed to remote areas that may not have the facilities, components, and personnel available to address maintenance needs. It also allows aircraft availability to be projected with a higher degree of confidence.

Although a maximum MFOP is desired it cannot come at an expense of excessive aircraft downtime. Maintaining or replacing a large set of systems every time an aircraft requires maintenance will increase MFOP but the time the aircraft is unavailable will likely be unacceptable.

Conventional methods of for handling aircraft scheduling have generally been considered satisfactory for their intended purpose. However, there is still a need in the art for improved aircraft scheduling methodologies. The present disclosure provides a solution for this need.

### SUMMARY OF THE INVENTION

A method is disclosed including identifying a plurality of maintenance schedules for a system each of which satisfy a minimum maintenance free operating period, monitoring and measuring a health of the system, utilizing the measured health of the system within a degradation model in order to produce a plurality of system degradation sequences, identifying the system degradation sequences from the model which do not satisfy the minimum maintenance free operating period, identifying at least one maintenance event from the plurality of maintenance schedules, and executing the at least one maintenance event based on the at least one identified maintenance event. The system can include a plurality of components. The system can be part of a vertical lift aircraft.

The degradation model can produce a plurality of simulation outcomes or be a Monte Carlo simulation. The Monte Carlo simulation can use loading coefficients picked from a distribution of plausible missions. The loading coefficients can be selected based on historical data. The loading coefficients can be selected based on predicted future conditions.

The degradation model can produce a set of predicted load values for at least one physical component of the system, each predicted load value from the set of predicted load values corresponding uniquely to one of an ordered sequence of index values, a set of predicted wear indicator values corresponding to at least on physical component of the system, each predicted wear indicator value of the set of predicted wear indicator values corresponding uniquely to one of the ordered sequence of index values based on one of the predicted load values from the set of predicted load values that corresponds to a sequentially previous index value and one of the predicted wear indicator values from the set of predicted wear indicator values that corresponds to the sequentially previous index value. The predicted amount of remaining useful life can be determined of at least one physical component based on the set of predicted wear indicator values.

The method can include identifying a component of the system that is least likely to reach an end of a next maintenance free operating period or identifying a component of the system that is unlikely to reach an end of a next maintenance free operating period, and repairing, replacing, or rehabilitating the identified component. The method can include amending previously determined maintenance schedules based on executed maintenance events.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a block diagram of a method for achieving the maintenance free operation period according an embodiment of the disclosure.

### DETAILED DESCRIPTION

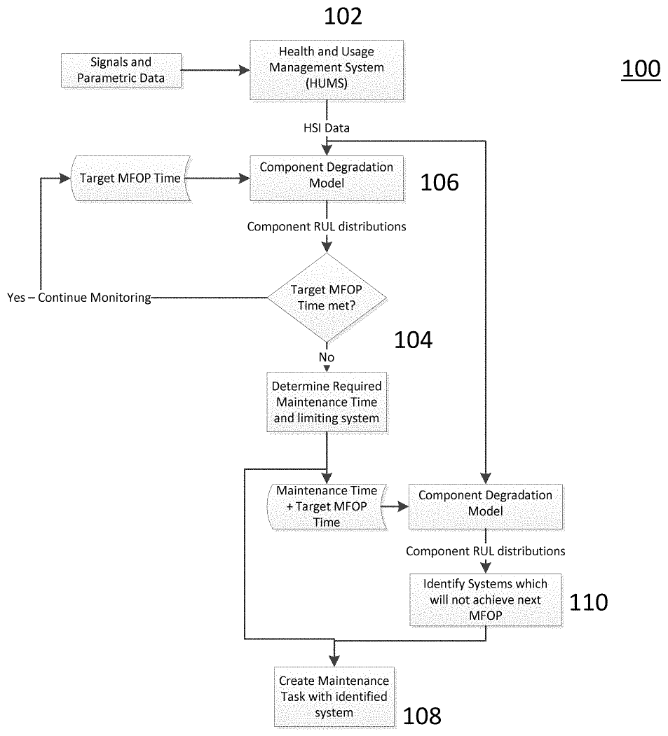

For purposes of explanation and illustration, and not limitation, a partial view of an exemplary embodiment of a method in accordance with the disclosure is shown in FIG. 1 and is designated generally by reference character 100. The method described herein can be used to forecast when a system is likely to need maintenance, and providing suggestions for maintaining other systems in order to achieve the maximum MFOP for an aircraft or aircraft system.

FIG. 1 shows steps of a method employing a HUMS Health State Indicator (HSI) data in combination 102 with a degradation model 106 which accounts for anticipated loads that would be applied to each component in each system in a given aircraft during a mission. Instead of using solely anticipated loads for a specific mission as was done by previous methods the timeline is extended to the time required for the MFOP. Additionally times that each simulation run reached a “failed” state are recorded. If a specific component or system cannot reach the required MFOP time with the required or predetermined level of certainty, a maintenance event is scheduled 108 or initialized at a time that allows for high confidence of system functionality. Once the maintenance time of the maintenance event is determined, the timeline is again extended to the next MFOP. With the model running continuously and analyzing the health of components and systems any systems that are predicted to not achieve the next MFOP will be pulled in to the maintenance event determined in the previous step.

The method further includes a plurality of maintenance schedules for a system of a vertical lift aircraft having a plurality of components, wherein each of the schedules of either the system of the individual component satisfy a minimum maintenance free operating period for the aircraft. The health of each of the systems and components 102 is monitored and measured, and by utilizing the measured health figure within a predetermined degradation model a plurality of system degradation sequences is produced 106. Along with the degradations sequences 106, a plurality of matching refurbishment plans are also composed 104. However, if all components are sufficiently likely to remain healthy during the remainder of the MFOP, then continue monitoring but do not schedule maintenance. If at any point the MFOP cannot be met then the required time and components/systems are identified. The model can then identify sequences and from the model which do not satisfy the desired minimum maintenance free operating period. The method then includes identifying at least one maintenance event from the plurality of maintenance schedules and executing the at least one maintenance event based on the at least one identified maintenance event.

The degradation model can produce a plurality of simulation outcomes or be a Monte Carlo simulation. The Monte Carlo simulation can use loading coefficients picked from a distribution of plausible missions. The loading coefficients can be selected based on historical data. The loading coefficients can be selected based on predicted future conditions.

The degradation model can produce a set of predicted load values for at least one physical component of the system, each predicted load value from the set of predicted load values corresponding uniquely to one of an ordered sequence of index values, a set of predicted wear indicator values corresponding to at least one physical component of the system, each predicted wear indicator value of the set of predicted wear indicator values corresponding uniquely to one of the ordered sequence of index values based on one of the predicted load values from the set of predicted load values that corresponds to a sequentially previous index value and one of the predicted wear indicator values from the set of predicted wear indicator values that corresponds to the sequentially previous index value. The predicted amount of remaining useful life can be determined of the at least one physical component based on the set of predicted wear indicator values.

The method can include identifying a component of the system that is least likely to reach an end of a next maintenance free operating period or identifying a component of the system that is unlikely to reach an end of a next maintenance free operating period, and repairing, replacing, or rehabilitating the identified component. The method can include amending previously determined maintenance schedules based on executed maintenance events.

While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method comprising:
identifying a plurality of maintenance schedules for a system each of which satisfy a minimum maintenance free operating period;
monitoring and measuring a health of the system;
utilizing the measured heath of the system within a degradation model in order to produce a plurality of system degradation sequences;
identifying at least one maintenance event from the plurality of maintenance schedules; and
executing the at least one maintenance event based on the at least one identified maintenance event and utilizing the system until the next MFOP after the at least one maintenance event has been executed.

2. The method of claim 1, wherein the system includes a plurality of components.

3. The method of claim 1, wherein the degradation model produces a plurality of simulation outcomes.

4. The method of claim 1, wherein the degradation model is a Monte Carlo simulation.

5. The method of claim 3, wherein the Monte Carlo simulation uses loading coefficients picked from a distribution of plausible missions.

6. The method of claim 4, wherein the loading coefficients are selected based on historical data.

7. The method of claim 4, wherein the loading coefficients are selected based on predicted future conditions.

8. The method of claim 1, wherein the degradation model produces:
a set of predicted load values for at least one physical component of the system, each predicted load value from the set of predicted load values corresponding uniquely to one of an ordered sequence of index values;
a set of predicted wear indicator values corresponding to at least one physical component of the system, each predicted wear indicator value of the set of predicted wear indicator values corresponding uniquely to one of the ordered sequence of index values based on one of the predicted load values from the set of predicted load values that corresponds to a sequentially previous index value and one of the predicted wear indicator values from the set of predicted wear indicator values that corresponds to the sequentially previous index value.

9. The method of claim 7, wherein a predicted amount of remaining useful life is determined of the at least one physical component based on the set of predicted wear indicator values.

10. The method of claim 1, further comprising identifying a component of the system that is least likely to reach an end of a next maintenance free operating period.

11. The method of claim 1, further comprising identifying a component or a plurality of components of the system that is unlikely to reach an end of a next maintenance free operating period.

12. The method of claim 10, further comprising repairing, replacing, or rehabilitating the identified component or plurality of components.

13. The method of claim 1, further comprising amending previously determined maintenance schedules based on executed maintenance events.

14. The method of claim 1, wherein the system is part of an aircraft.

15. The method of claim 1, wherein the system is part of vertical lift aircraft.
